(19) United States
(12) Patent Application Publication
(10) Pub. No.: US 2026/0211982 A1
(43) Pub. Date: Jul. 23, 2026

(54) System and Method for Asset Rights Enforcement Using a Dual-Token Trust Architecture

(71) Applicant: Amy Pearson, Glenview, IL (US)

(72) Inventors: Amy Pearson, Glenview, IL (US); Bobby Elijah Aviv, New York, NY (US); Brian Aster, Lake Zurich, IL (US)

(73) Assignee: Amy Pearson, Glenview, IL (US)

(21) Appl. No.: 19/438,533

(22) Filed: Dec. 31, 2025

Related U.S. Application Data
(60) Provisional application No. 63/747,534, filed on Jan. 21, 2025.

(51) Int. Cl. G06F 21/10; G06Q 20/36

(52) U.S. Cl. CPC G06F 21/1014; G06F 21/1076; G06Q 20/36; G06Q 2220/00

(57) ABSTRACT

Systems and methods are disclosed for enforcing rights in an asset using a dual-token trust architecture. An asset to be held in trust is defined and stored in memory. A trustee token, representing custodial or fiduciary control of the asset, is generated and transferred to a trustee wallet address, with the transfer recorded on a blockchain. A beneficiary token is generated and transferred to a beneficiary wallet address distinct from the trustee wallet address. The beneficiary token functions as a cryptographic receipt evidencing one or more enforceable rights in the asset, while ownership or control of the asset remains with the trustee via the trustee token. The disclosed architecture separates asset custody from beneficiary rights and enables enforceable asset management across a wide range of asset types, including intellectual property rights, licenses, tickets or access credentials, digital currencies or stablecoins, and tokenized real-world assets.

### BACKGROUND OF THE INVENTION

A non-fungible token (NFT) is digital representation of a real, unique asset with proof of ownership/title stored in a digitally distributed, decentralized, immutable, oftentimes public digital ledger (a blockchain). Blockchains are fundamentally ledgers containing a history of transactions. The ledger is immutable due to the cryptography employed to construct the chain.

NFTs (also called “smart contracts”) are written with software code that governs actions of the NFTs such as verifying ownership and managing the transferability. NFTs can be programmed beyond the basics of ownership and transferability. A common use case for NFTs is tracking ownership of popular GIFs, works of visual or sonic art, and tangible items, such as sports trading cards or any particular goods for which there is sufficient value and scarcity to warrant tracking their ownership on the blockchain. NFTs are currently mostly used for selling art and music. NFTs contain a description of the asset and provide a link to the asset.

Marketplaces (NFT exchanges) for these virtual goods have also become commonplace, such as OpenSea, Nifty Gateway, Rarible and SuperRare.

As of the drafting of this patent application, there are only two different types of NFTs supported on OpenSea—ERC-721 and ERC-1155. To make the process of creating an NFT simpler, on OpenSea, the NFT used to sell an asset depends on the options selected during creation of the auction. For example, if a creator selects that there is only one asset to sell (a supply of one), the ERC-721 contract will be used. If, however, the creator selects that there are more than one of the same asset (a supply greater than one), the NFT that OpenSea uses to create the auction is the ERC-1155, a semi-fungible token. Transparent to the asset creator, in selecting a supply of more than one, the asset creator has selected their intent to use the ERC-1155 smart contract. FIG. 1 shows an example of the prior art process for selling an asset on a standard NFT platform such as OpenSea. Selecting a supply of greater than one is part of the auction parameters. At the end of the process, ownership of each of the assets in the supply would be transferred to the buyers and recorded on the creator's selected blockchain.

### Royalty Fee/Secondary Sales

A valuable aspect of NFT technology is the ability to include an (ongoing) royalty (also known as a “royalty fee” or a “creator fee”) for the original artist/creator in the NFT code (smart contract) specifying that they will receive a set percentage of each (future) sale of the NFT after the first sale (each future sale, a “secondary sale”). Some platforms enable the asset creator to set a royalty rate that the asset creator will receive for secondary sales of the asset. Recently various platforms have experimented with “optional” creator royalties, minimum creator royalties, and no creator royalties in order to support professional NFT traders who generally do not appreciate creator royalties. If smart contracts are to be held up as actual contracts, the intentions of the creator must be maintained. The platform should not be able to unilaterally decide not to enforce creator royalties.

The ERC-721C standard introduces a mechanism to enforce guaranteed creator royalties by restricting transfers of NFTs to only approved platforms and wallets that adhere to the ERC-721C standard. By doing so, ERC-721C ensures that royalties embedded in the smart contract are honored, as these compliant platforms will execute the royalty logic on every secondary sale. This approach gives creators more control over their royalties and aligns platform actions with creator intentions.

However, ERC-721C relies heavily on marketplace compliance. If a marketplace does not adhere to the ERC-721C standard, the royalty logic can be bypassed. Additionally, the transfer restrictions imposed by ERC-721C can reduce the liquidity and flexibility of NFTs, potentially limiting their resale opportunities to a smaller pool of compliant platforms.

### NFT Wrapping

Wrapping is a significant challenge to enforcing royalties, even with standards like ERC-721C. NFT wrappers are smart contracts that encapsulate (or “wrap”) an original NFT within a new token, creating a “wrapped” NFT that can provide additional functionalities or attributes without altering the original asset. Wrapping NFTs allows for added features like fractional ownership, lending/borrowing, or integrating an asset with new standards. However, wrapping can also strip the original NFT of its embedded royalty logic.

When wrapping an NFT, the original token is first transferred to a wrapper smart contract, which holds it securely. This contract acts as a custodian, ensuring the wrapped token retains its connection to the original. The contract verifies the NFT's authenticity, ownership, and any necessary metadata before proceeding. The wrapper contract then mints a new token (often an ERC-721, ERC-1155, or even an ERC-20 token), representing the original NFT. This wrapped version can be programmed to selectively include or exclude specific metadata or attributes of the original NFT. The wrapped NFT is then sold or traded without enforcing the royalties specified by the creator, effectively bypassing mechanisms like ERC-721C.

Wrapping an NFT can enable it to work with standards it wouldn't otherwise be compatible with. For instance, an older ERC-721 NFT can be wrapped into a newer standard (like ERC-1155) for easier integration across marketplaces and DeFi platforms. When the holder of the wrapped NFT wishes to redeem the original asset, they can return the wrapped token to the smart contract. The wrapper contract “unwraps” the NFT by burning the wrapped token and returning the original NFT to the holder. This step effectively dissolves the wrapper, restoring full control over the original NFT without any added terms or conditions.

If someone who doesn't own the NFT tries to create a wrapper, they won't have access to the original token to transfer it into the wrapper contract. As a result, any “wrapped” token they create won't be linked to the original NFT and won't have any connection or value tied to it. Without ownership, a wrapper created by a non-owner would be merely a replica or a counterfeit version, lacking any real link to the original NFT. It would not be verifiable as a legitimate wrapped asset, as the original remains with the rightful owner.

Wrapping not only sidesteps creator royalties but also presents challenges to authenticity and enforcement. For instance, while the wrapper contract may link to the original NFT's metadata, buyers often prioritize the flexibility and additional features of the wrapped token over respecting the terms of the original asset. This disconnection underscores the broader challenges in enforcing royalties on decentralized platforms, where user autonomy often conflicts with creator preferences.

Methods to prevent wrapping include:
Restricted Transfers—NFT creators can design their smart contracts to only allow transfers to a specific set of approved addresses (e.g., trusted wallets or approved marketplaces). This restricts transfers to wrapping contracts by excluding them from the list of approved addresses.
Anti-Wrapping Clauses—Developers can add specific conditions that make wrapping more challenging, such as requiring user confirmations or blocking transfers to unknown smart contracts. However, this approach can limit the token's interoperability and restrict it from being used on many platforms.
Off-Chain Agreements—Creators can also create off-chain agreements that prohibit users from wrapping their NFTs, especially for exclusive or high-value assets. Similarly, platforms such as NBA Top Shot create terms of service agreement that prohibit NFT wrapping. This approach on users complying with terms of service is hard to enforce in decentralized spaces where users may still wrap and trade NFTs on alternative platforms.
Unique Metadata or Other Token Features—Unique metadata or other token features such as proof-of-authenticity can also be used to uniquely identify the original NFT, making it distinguishable from wrapped versions. This approach relies on platform support and user awareness. It may not prevent wrapping but could help buyers verify authenticity and reduce the value of wrapped versions.

While some of these strategies make wrapping more difficult, there's no surefire way to fully prevent wrapping, especially on a decentralized blockchain. Users could still transfer the NFT to a personal wallet and then send it to a wrapping contract outside the direct transfer function, which is harder to control. At best, creators and marketplaces can add barriers that discourage it, but users can generally still find ways around them. Wrapping is often seen as a form of asset freedom in decentralized ecosystems, so achieving full control over an NFT's transferability requires balancing user autonomy with creator preferences.

### Transfer Restriction in Contract Standards

Current smart contract standards that restrict transfer or have transfer controls are:
ERC-1404—Simple Restricted Token Standard-This token allows issuers to implement custom rules that restrict transfers based on specific conditions or allow transfers only to certain wallets. RC-1404 includes a function called detectTransferRestriction, which checks whether a transfer is allowed based on pre-defined rules, and messageForTransferRestriction, which provides feedback on why a transfer is blocked if it doesn't meet the conditions. ERC-1404 is less flexible than ERC-721 or ERC-1155 for NFTs.
ERC-721C—Transfer-Controlled NFTs-This token restricts where and to whom an NFT can be transferred, allowing only authorized platforms or approved wallets to interact with the token. ERC-721C contracts can have an allowlist of approved addresses (like specific wallets or marketplaces), restricting transfers only to those listed addresses. This makes it possible to ensure royalties and other terms are respected by only allowing transfers to compliant platforms. These transfer restrictions can limit the NFTs liquidity and flexibility, potentially reducing resale opportunities if the approved platforms are limited.
ERC-1400—Security Token Standards (with transfer restrictions)-This token standard enforces compliance rules (e.g., KYC/AML) through functions like canTransfer and getDocument, which restrict transfers to verified or approved wallets only. ERC-1400 combines features from ERC-20 and ERC-777 with additional restrictions, making it primarily suited for fungible security tokens, not NFTs.
ERC-725/735—Identity-Based Transfer Control-A system could be built where only verified accounts with a decentralized identity (using ERC-725 for identity management) are eligible to receive certain tokens. ERC-735 (claim management) enables this by allowing accounts to hold verifiable claims, such as KYC status, which can be checked before transferring tokens.
Custom smart contracts can implement Role-Based Access Control by creating specific roles (like “admin” or “approved transferrer”) to limit who can initiate transfers or approve certain destinations. This flexibility can be implemented in any ERC standard (e.g., ERC-721 or ERC-20) through custom code.
ERC-777—Custom Transfer Hooks-This is an upgradable token standard which includes operator hooks (e.g., “send hooks,” “receive hooks”) that can restrict transfers based on conditions, enabling complex transfer control logic. ERC-777 is mostly used for fungible tokens where complex transfer logic is needed (e.g., compliance or rewards).

While these standards prohibit off-platform or enabled transfer to allowed/verified wallets, they can still be wrapped.

### Pricing Restrictions in NFTs

On a decentralized network like Ethereum, enforcing pricing restrictions conflicts with the principles of open, permissionless markets. Additionally, marketplace platforms generally don't interact directly with token contracts to check pricing conditions. As a result, even if an NFT's original contract contains price restrictions, buyers can circumvent them by listing the asset on marketplaces that don't enforce these rules.

While some custom contract logic and closed-ecosystem models can impose limited pricing controls, no standard currently exists that universally enforces resale price caps across open marketplaces. For a truly decentralized marketplace, preventing price increases would require more widespread platform-level support for price restrictions, which is not currently part of the Ethereum ecosystem.

### Need for Creator Royalties

As the blockchain industry continues to flourish, NFTs have enormous potential to change how creative careers are started and how asset creators are paid. To incentivize asset creators, the ability to collect royalties from each secondary sale must be guaranteed. However, there is currently no way to guarantee that royalties will be enforced. Royalty enforcement is currently left up to marketplaces.

### Trustees

A trustee is any person or organization that holds the legal title of an asset or group of assets for another person, called the grantor. A trustee is granted this legal title through a trust in which they hold title to the assets held in trust for the benefit of others. The people or entities who benefit from the trust are called beneficiaries.

A trust is a legal entity in which a person or party who owns assets (also called a grantor) gives another party (the trustee) title to those assets or property for the benefit of one or more third parties (beneficiaries). For example, a trust might be created to provide legal protection for the grantor's assets and ensure they are appropriately distributed. The trustee is charged with ensuring that the grantor's wishes are fulfilled.

A trustee is thus responsible for properly managing all property and other assets placed in the trust for the beneficiaries. A trustee's specific duties are unique to the trust agreement and are dictated by the type of assets held in the trust. For instance, if a trust holds various rental properties intended to be used for income, it will be the trustee's duty to ensure that those properties are managed, maintained, occupied, and generating income.

Trustees are also required to financially manage and oversee accounts within a trust when it is made up of other investments, such as equities in a brokerage account.

All trustees have general guidelines and responsibilities, regardless of the specifics in the trust agreement. Trustees generally assume the following duties:
Act as a fiduciary: The role of the trustee is to ensure the trust is administered in accordance with the grantor's wishes.
Ensure the safety of the assets: Accounting for the funds and assets within the trust and understanding who the beneficiaries are and what their rights are. Trustees also ensure trust assets are kept separate from other assets.
Administer the trust: Keeping records of all transactions and distributing assets as required.
File reports: Reporting to state and federal regulators as required and keeping the beneficiaries updated.
Make decisions: A trustee will be required to make decisions about the assets from time to time as circumstances change. The decisions must align with the grantor's wishes.
Invest: Any investable assets must be invested, allocated, or adjusted as needed in accordance with the wishes of the grantor.
Communicate with beneficiaries: Trustees should initiate communication with the beneficiaries, not wait for contact. Emails, phone calls, or other methods can be used to check in. Beneficiaries should clearly understand the grantor's wishes for the trust, and the trustee should be prepared to answer questions.

Digital asset trusts (such as Hex Trust's Hex Safe, Anchorage Digital, and Trust Wallet) currently exist, but do not exist to enable guaranteed creator royalties or prevent ticket scalping.

What is needed is:
an NFT marketplace that can generate NFTs that ensure compliance with the grantor's wishes to receive secondary sales royalties—no matter the platform; and
a ticketing platform that can generate ticket NFTs that ensure compliance with the performer's wishes—that the tickets cannot be scalped.

### BRIEF SUMMARY OF THE INVENTION

To ensure guaranteed creator royalties, an unscalpable ticket, or a revokable NFT, an asset generating platform (such as an NFT Creator Marketplace, or NFT Ticketing Platform) generates a trust asset (NFT) to be held by a Trustee for the beneficiaries. The beneficiaries are the asset creator (e.g., musician with a song or concert tickets who gets paid for the first sale and gets paid royalties for subsequent sales), first buyer, and subsequent buyers.

As an example, a Songwriter sells the full copyright of a song to Buyer. Instead of a standard NFT, which can be wrapped, a Trustee holds the trust asset for the benefit of the parties. The Buyer still receives payment for a subsequent transfer. The Songwriter still receives royalties and payment for the first sale. The only change is that the Trustee is the owner of the trust asset. When Songwriter (Asset Creator/Original Owner) decides to use the TrusteeNFT to manage its rights, Creator Marketplace or NFT Ticketing platform (as Trustee) creates a TrusteeNFT that is owned by the ‘Trustee for the benefit of Songwriter (Asset Creator/Original Owner)’ and is transferred to ‘Trustee for the benefit of Buyer and Songwriter.’ This can be accomplished in many ways using NFTs, smart contracts, and centralized servers. Because the Asset is always owned by the Trustee, per agreement by the Trustee with the Asset Creator/Original Owner, the Asset cannot be wrapped into another smart contract and the platform (or Buyer/First Buyer) can't avoid paying royalties on any secondary sales. Further, as a fiduciary for the beneficiaries, the Trustee must abide by the terms set with the Asset Creator/Original Owner and, for example, only sell the trust asset on the allowed platform(s) and/or only sell the tickets at the original price—per the originally agreed upon terms. For example, if a musician does not want tickets to be scalped, the Trustee can only sell the ticket at the original price.

The TrusteeNFT system can generate one NFT that provides benefits to different roles (e.g., original owner/asset creator, trustee, beneficiary/buyer) defined in the TrusteeNFT. The TrusteeNFT ecosystem is shown in FIG. 2. Although the TrusteeNFT system can be implemented where multiple (two or more) NFTs practice the invention, the foundational and only required NFT is the TrusteeNFT. The TrusteeNFT is the NFT that gets transferred from the original asset owner or creator (e.g., artist or musician) to the trustee (e.g., NFT Creator Marketplace Platform, NFT Ticketing Platform, trustee crypto wallet, or DAO).

In the preferred embodiment, crypto wallets would be able to interpret the beneficiary fields and transfer interests into (or show the interests in) each of the beneficiary's wallets. By default, wallets like MetaMask or others are designed to show token ownership and balances, not specific rights or obligations such as royalty entitlements. Royalty information can be made accessible and visible by using on-chain or off-chain metadata or events for tracking or by working with wallet companies such as MetaMask to enable beneficiary visibility. Alternatively, additional NFTs can be created to show the interests created by the TrusteeNFT.

In one embodiment, using any NFT token, for each transfer/purchase of a digital asset, the only blockchain/ledger field that changes in the TrusteeNFT is the beneficiary. Beneficiary information can be included on-chain or off-chain. The trustee would remain the owner of the asset. An optional NFT that can be created is a Beneficiary NFT, the NFT that the Buyer/Beneficiary can only use to prove its beneficiary status—for proof in the Buyer/Beneficiary's wallet of ownership of those rights. The Beneficiary NFT represents the Buyer's purchase of the rights to receive its share of the royalties coming from the next “sale” of the Asset. The Beneficiary NFT is preferably a soulbound token that cannot be transferred and can be revoked by the Trustee upon the Buyer's sale of his right to collect royalties from the Asset. As Trustee of the Asset, the Trustee owes both Buyer and the Asset Creator a fiduciary duty to pay each of them the appropriate percentage of royalties. Upon the sale of the Asset to a new buyer, the Beneficiary (Buyer) NFT can be burned. In this embodiment, upon a transfer/purchase: (1) the seller receives payment for the purchase, and the creator receives secondary sales royalties); (2) the seller's Beneficiary NFT (soul-bound token) is revoked/burned; (3) a new Beneficiary NFT (soul-bound token) is generated representing the rights transferred from the seller to the buyer; and (4) on-chain or off-chain data with respect to the TrusteeNFT is updated to show that the new beneficiary is the buyer. Another optional NFT that can be created is a Grantor NFT, an NFT that the original owner/creator can use to (1) prove status as the original owner/creator of the asset; (2) prove status as a beneficiary of the trust; and (3) transfer remaining rights and benefits of the asset that are not transferred to the Trustee.

In this embodiment, an ERC-721, or other standard smart contract that allows transfer control/restrictions, can be used to prevent the trustee from transferring the asset to anyone. Further custom coding would allow only the trustee (or platform acting on its behalf) to update the beneficiary information using an access control function to restrict who can make this change. An event can be emitted to show beneficiary updates for better transparency and traceability.

In another embodiment, with each transfer/purchase, a new wallet address is generated in the trustee's multi-wallet to hold the asset for the new buyer. The beneficiary is first the Original Owner/Asset Creator (Original Owner's wallet address) and then, upon a sale, becomes the Buyer (Buyer's wallet address). In this case, however, the platform (or an independent trustee or DAO) would have the multi-wallet and hold assets for the sellers and the buyers in separate accounts. In this embodiment, Beneficiary NFTs and Grantor NFTs can also be generated to visibly show the ownership interests of the Original Owner/Asset Creator and Grantor in their wallets.

In the event that one person holds both the Grantor NFT and the Beneficiary NFT, the person may burn or wrap the TrusteeNFT and sever the relationship with the Trustee.

In the case of an NFT ticketing system, the TrusteeNFT is used to (1) convey ownership of the ticket asset to the Trustee; (2) establish responsibilities of the Trustee; (3) set pricing restrictions (if allowed in the NFT standard such as ERC-721C); and (4) set forth trust properties such as revocability. If pricing restrictions are not allowed within the selected smart contract standard, the Trustee would be required to implement its own pricing controls such as: (a) using a “BuyItNow” type of fixed-price sale and resale of the ticket; or (b) creating and transferring to the buyer a soul-bound NFT ticket that can be destroyed or revoked upon a sale.

### BRIEF DESCRIPTION OF THE DRAWINGS

Illustrated in the accompanying drawing(s) are embodiments of the present invention in such drawings:

FIG. 1a shows an example of the prior art process for selling a work on an NFT marketplace where minting occurs before the sale;

FIG. 1b shows the called “lazy minting” prior art process for selling a work on an NFT marketplace where minting occurs after the sale;

FIG. 2 shows the TrusteeNFT ecosystem;

FIG. 3a shows the first part of the first embodiment of the invention where the Trustee uses a first address in the Trustee's multi-wallet to hold the asset for the Asset Creator (Original Owner) and a second address in the Trustee's multi-wallet (for the Buyer) to receive the asset upon a sale to the Buyer;

FIG. 3b shows the second part of the first embodiment of the invention where the Trustee uses third address in the Trustee's multi-wallet to receive the asset upon a sale to a NewBuyer;

FIG. 4a shows the first part of the second embodiment of the invention where the Trustee is not allowed to transfer the asset, but upon a sale of the asset to the Buyer, the TrusteeNFT can and does modify owner-beneficiary information—changing it from the wallet address of Asset Creator (Original Owner) to the wallet address of Buyer;

FIG. 4b shows the second part of the second embodiment of the invention where upon a sale of the asset to the NewBuyer, the TrusteeNFT modifies owner-beneficiary information—changing it from the wallet address of Buyer to the wallet address of NewBuyer;

FIG. 5a shows the first part of the third embodiment of the invention where the Trustee uses a first address in the Trustee's multi-wallet to hold the ticket for the Original Owner and a second address in the Trustee's multi-wallet (for the Buyer) to receive the ticket upon a sale to the Buyer;

FIG. 5b shows the second part of the third embodiment of the invention where the Trustee uses third address in the Trustee's multi-wallet (for the NewBuyer) to receive the ticket upon a sale to a NewBuyer;

FIG. 6a shows the first part of the fourth embodiment of the invention where the Trustee is not allowed to transfer the ticket, but upon a sale of the ticket to the Buyer, the TrusteeNFT modifies owner-beneficiary information—changing it from the wallet address of Original Owner to the wallet address of Buyer;

FIG. 6b shows the second part of the fourth embodiment of the invention where upon a sale of the ticket to the NewBuyer, the TrusteeNFT modifies owner-beneficiary information—changing it from the wallet address of Buyer to the wallet address of NewBuyer; and

FIG. 7 shows the structure of the Trustee NFT Platform.

The above-described figures illustrate the described apparatus and its method of use in several preferred embodiments, which are further defined in detail in the following description. Those having ordinary skill in the art may be able to make alterations and modifications to what is described herein without departing from its spirit and scope. Therefore, it must be understood that what is illustrated is set forth only for the purposes of example and that it should not be taken as a limitation in the scope of the present apparatus and method of use.

### DETAILED DESCRIPTION OF THE INVENTION

A musician (the “Asset Creator”) creates an asset such as the copyright to a new song. The Asset Creator wants guaranteed receipt of secondary sale royalties so the Asset Creator, through an NFT marketplace platform, creates a TrusteeNFT for the copyright (the “Asset”). The TrusteeNFT is used to (1) convey ownership of the asset to the Trustee; (2) establish responsibilities of the Trustee; (3) set forth an original owner/creator royalty percentage for secondary sales of the asset; and (4) set forth trust properties such as revocability.

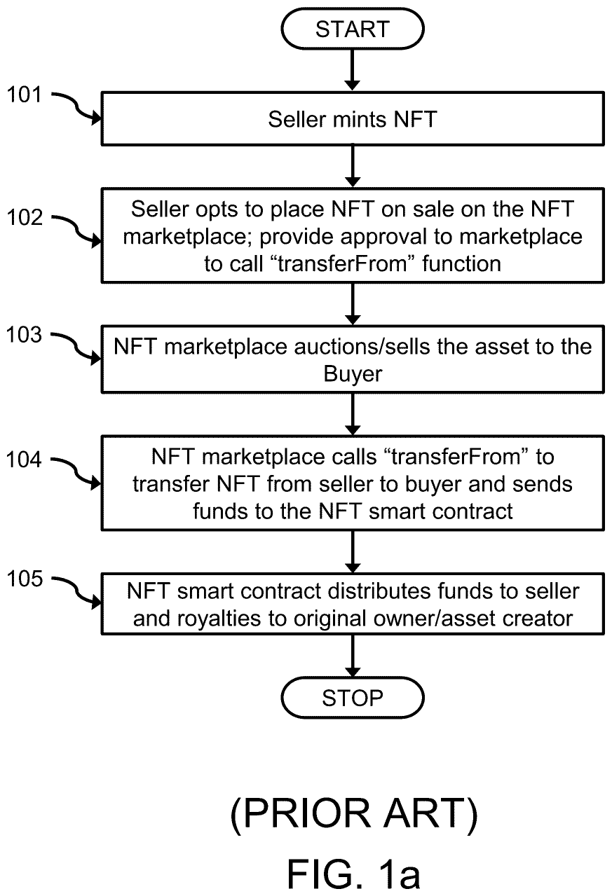

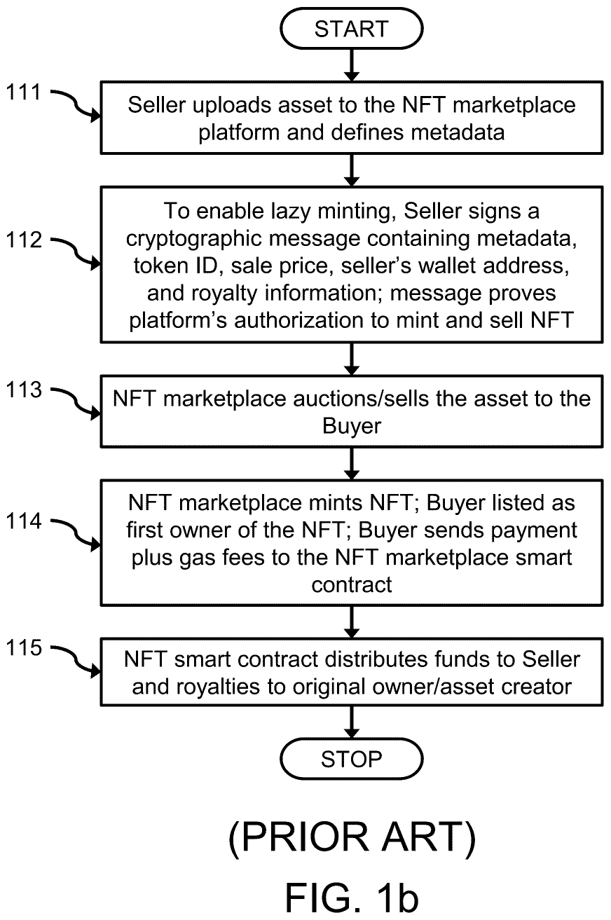

In the prior art as shown in FIG. 1a, first an NFT is minted on an NFT marketplace platform such as OpenSea using a “mint” function 101. The seller becomes the owner of the NFT—as the blockchain records the wallet address of the seller as “owner” and the unique ID of the NFT as “tokenId.” When the seller wants to place their NFT for sale on OpenSea (or some other platform), OpenSea prompts the seller to approve their smart contract. The seller's wallet address executes an “approve” transaction allowing OpenSea to call the “transferFrom” function when the sale later occurs 102. This grants OpenSea permission to transfer the specific NFT from the seller (to the eventual buyer). When the buyer purchases the NFT 103, OpenSea's smart contract calls the “transferFrom” function to move the NFT from the seller's address to the buyer's address and the buyer sends funds to the OpenSea smart contract 104. The NFT smart contract then distributes funds to the seller and royalties to the original owner/creator 105. The permission to transfer resets (approval is withdrawn) after the sale to buyer.

“Lazy Minting” was developed so that sellers could place their works for sale without having to pay for minting. FIG. 1b shows the “lazing minting” process. Seller uploads an asset to the NFT marketplace platform and defines metadata 111. To enable lazy minting, Seller signs a cryptographic message containing metadata, token ID, sale price, seller's wallet address, and royalty information. The message proves the platform's authorization to mint and sell NFT 112. NFT marketplace auctions/sells the asset to the Buyer 113. NFT marketplace mints NFT. The Buyer listed as first owner of the NFT. The Buyer sends payment plus gas fees to the NFT marketplace smart contract 114. NFT smart contract distributes funds to Seller and royalties to original owner/asset creator 115.

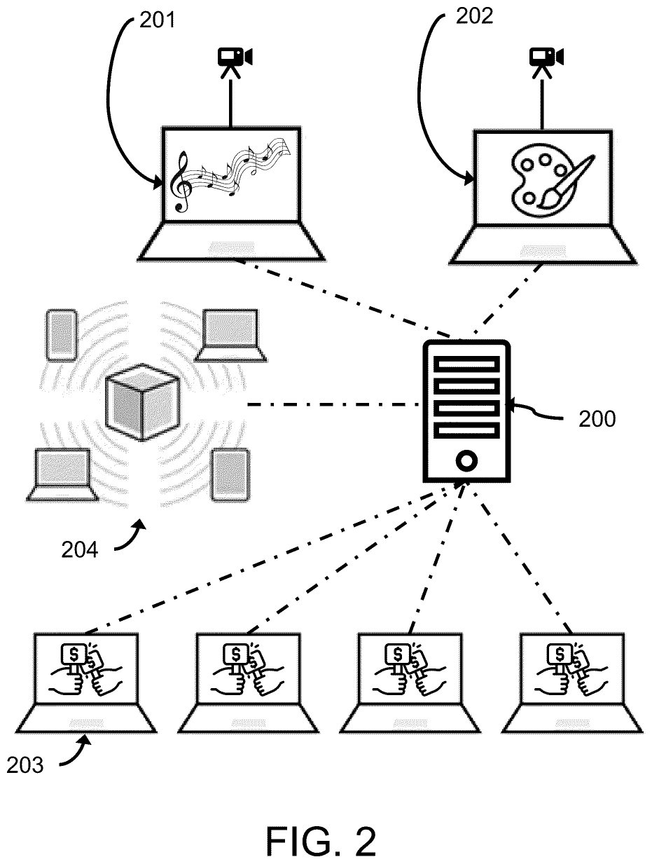

FIG. 2 shows the TrusteeNFT ecosystem where an asset creator such as a musician (using its computing device 201) or an artist (using its computing device 202) uploads an asset (such as an mp3 of a song or a jpeg for a piece of art) or representation of an asset (such as a description of a physical piece of art or a copyright) to a marketplace/trustee server 200 to act as a trustee for the asset. The asset can be, for example, a video of a song's creation, the copyright rights to the song, a physical piece of art, a jpeg of that art, or a ticket. A trustee is needed to ensure that (1) in the case where there are creator royalties, the musician or artist can be guaranteed a royalty fee (e.g., 5%) for every secondary sale of the asset; and (2) in the case of ticket sale, the seller (e.g., musician holding a concert) is guaranteed that his fans won't have to pay more for a resold ticket. A smart contract is required for its immutability and its ability to distribute funds in the manner originally intended by the asset creator. NFT Marketplace/Trustee server 200 assists the asset creator(s) 201, 202 in creating a TrusteeNFT minting the TrusteeNFT on a blockchain 204. The NFT Marketplace/Trustee server 200 (through a wallet address, multi-wallet, or DAO) can act as the trustee and hold the asset in trust for the asset creator 201, 202 so that the trustee (1) can enforce the asset creator's royalty fee (e.g., 5%) for all secondary sales to buyers such as Buyer 203; and (2) guarantee that fans won't pay more than the original sales price for a resold ticket.

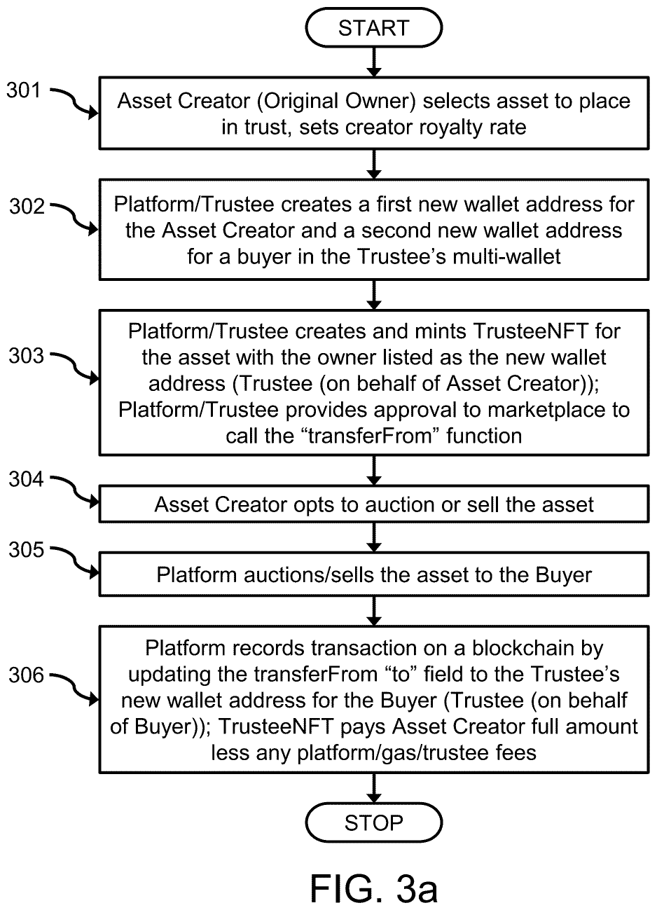

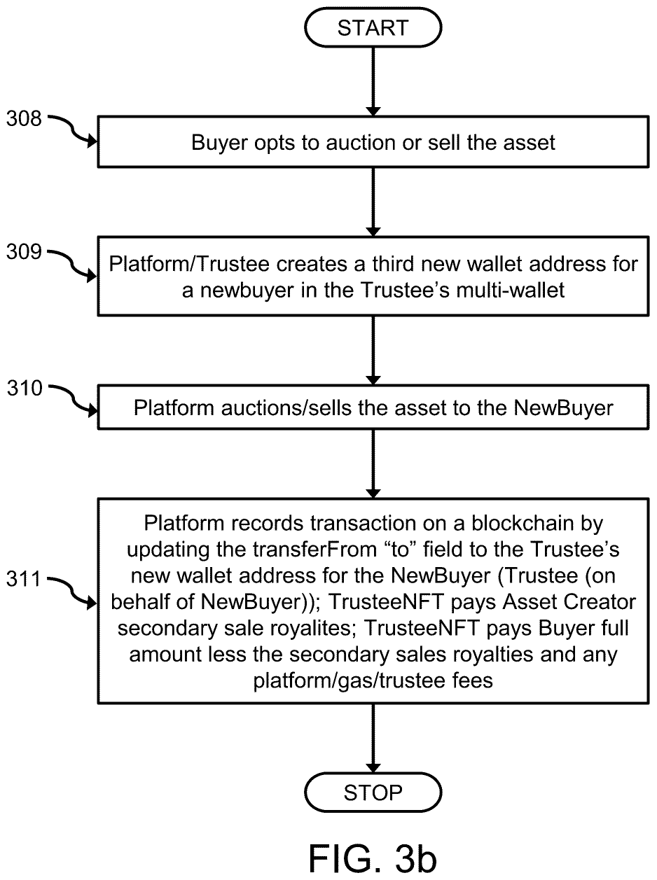

FIGS. 3a, 3b, 4a, 4b, 5a, 5b, 6a, and 6b are written to demonstrate how an asset creator (such as a musician or artist) can create and use a TrusteeNFT to: (1) ensure that they will be guaranteed to receive all earned secondary sales royalties; (2) ensure that that their TrusteeNFTs can't be wrapped; and (3) utilize traditional legal methods of trust law to enforce their rights should the trustee not abide by the asset creator's (trustee guarantor's) wishes.

FIG. 3a and FIG. 3b show the first embodiment of the invention where the Trustee uses a multi-wallet to keep interests separate while transferring interests in an asset from a seller to buyer.

FIG. 3a shows the first part of the first embodiment of the invention where the Trustee uses a first address in the Trustee's multi-wallet to hold the asset for the Asset Creator (Original Owner) and a second address in the Trustee's multi-wallet (for the Buyer) to receive the asset upon a sale to the Buyer. First, the Asset Creator selects an asset to place in trust and sets a (guaranteed) creator royalty rate 301. The NFT Creator Marketplace platform (as Trustee) creates a first new wallet address for the Asset Creator and a second new wallet address for a (future) buyer in the Trustee's multi-wallet 302. The NFT Creator Marketplace platform creates and mints a TrusteeNFT for the asset with the owner listed as the new wallet address for the Asset Creator (a wallet address representing “Trustee (for the benefit of Asset Creator).” The NFT Creator Marketplace platform provides approval to marketplace to call the “transferFrom” function—transfer will be to the pre-created wallet address for the (future) buyer 303.

The Asset Creator (or the Trustee) then opts to auction or sell the asset 304 and the NFT Creator Marketplace Platform auctions or sells the asset to Buyer 305. The NFT Creator Marketplace Platform records the transaction on a blockchain by updating the transferFrom “to” field to the Trustee's new wallet address for the Buyer (a wallet address representing “Trustee (for the benefit of Buyer)”). The TrusteeNFT then pays Asset Creator full amount less any platform/gas/trustee fees 306.

Examples of multi-wallet solutions that could handle this arrangement would be Gnosis Safe, Argent, SafeSnap, Multis, MetaMask (multi-account), Ambire Wallet, and Trust Wallet.

In buying a TrusteeNFT, buyers are entering into (and will need to agree by the terms and conditions of the marketplace platform to enter into) a client-trust relationship with the trustee. Buyer will need to be made aware that they will not actually be holding the asset, but will have a trustee holding the asset for them. Concerns regarding ownership can be assuaged by transferring a Beneficiary NFT to the Buyer or emitting an event indicating that the Buyer's wallet address is receiving an interest in the asset.

FIG. 3b shows the second part of the first embodiment of the invention where the Trustee uses third address in the Trustee's multi-wallet to receive the asset upon a sale to a NewBuyer. The Buyer first opts to auction or sell the asset 308. The Creator Marketplace platform (as Trustee) creates a third new wallet address for a (future) newbuyer in the Trustee's multi-wallet 309. The NFT Ticket Platform auctions or sells the asset to NewBuyer 310. The NFT Ticket Platform records the transaction on a blockchain by updating the transferFrom “to” field to the Trustee's new wallet address for the NewBuyer (a wallet address representing “Trustee (for the benefit of NewBuyer)”). The TrusteeNFT then pays Asset Creator the guaranteed secondary sale royalties and pays the Buyer the full amount less the guaranteed secondary sales royalties and any platform/gas/trustee fees 311.

As a trustee, the trustee is required to hold the asset in trust for the beneficiaries. In the first sale, the Asset Creator is the only beneficiary—both as the seller the asset creator who is to receive the guaranteed secondary sales royalties. In the second sale, the Buyer (as seller) is a beneficiary and the Asset Creator is also a beneficiary who still receives the guaranteed secondary sales royalties.

By their nature, NFTs/smart contracts help the trustee abide by the guidelines and responsibilities/duties it owes to the beneficiaries. The Guarantor (asset creator/original owner) is able to see each transaction recorded on the public blockchain and verify that: the trust is administered in accordance with the grantor's wishes; the beneficiaries (and the public) can see rights granted to the beneficiaries; assets are kept separate from other assets by using a multi-wallet (or other means to indicate a separate interest for the beneficiaries, such as beneficiary metadata, discussed later); all transactions are recorded; and no changes have been made to the NFT—as long as the TrusteeNFT emits events to all beneficiaries any time the TrusteeNFT is modified or the asset is sold/resold.

Utilizing a multi-wallet with the trustee being listed as the owner also maintains anonymity of the actual beneficiaries, adding an extra layer of privacy. Should a member of the public want to contact the current NFT owner, the owner could communicate via the Trustee's wallet address—if the Trustee uses on-chain messaging protocols or an ENS profile or otherwise indicates contact information through an NFT Creator Marketplace profile.

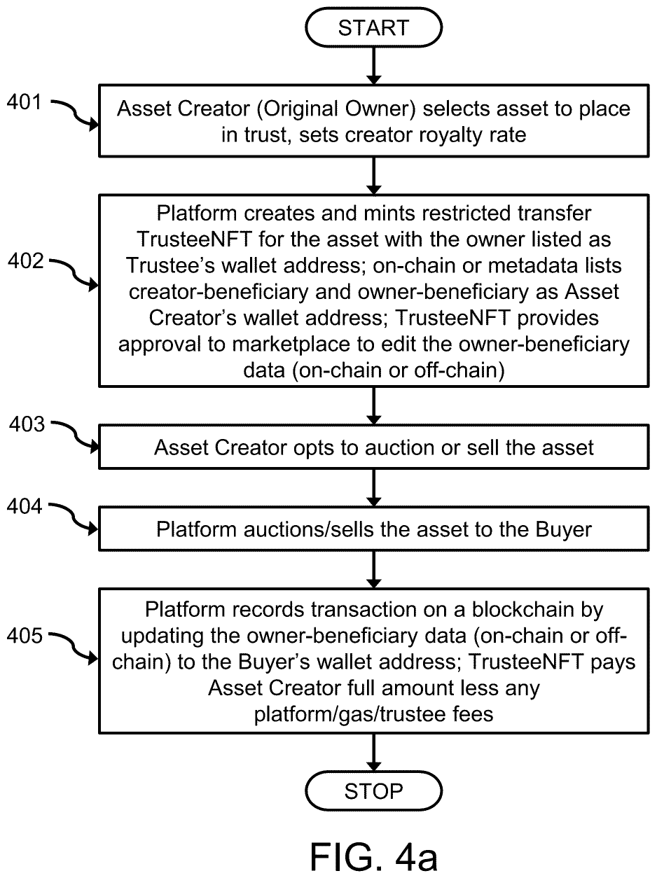

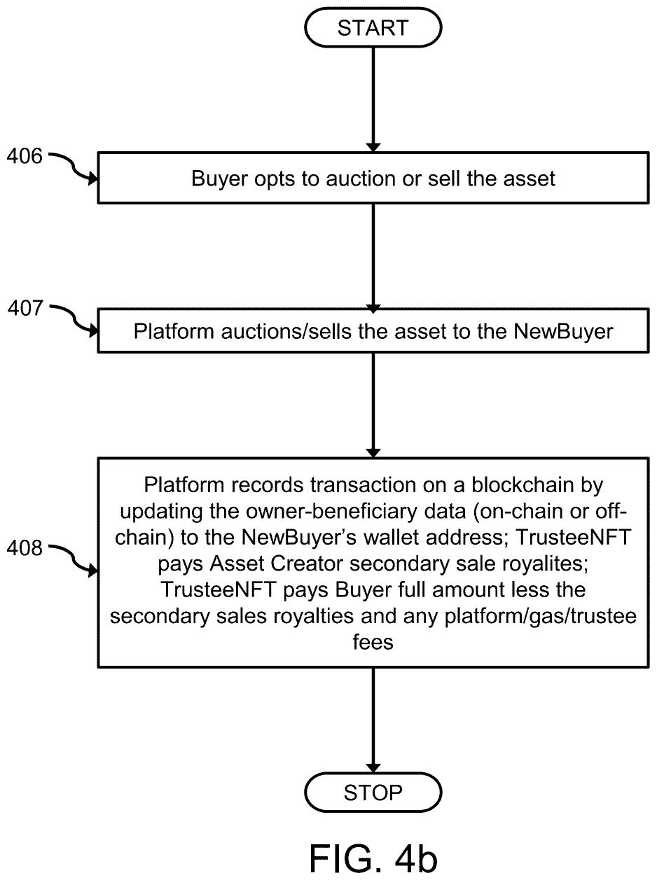

FIG. 4a and FIG. 4b show the second embodiment of the invention where the Trustee's wallet holds the asset for the beneficiaries. Upon a sale, the TrusteeNFT only modifies owner-benficiary information to keep track of the current beneficiary.

FIG. 4a shows the first part of the second embodiment of the invention where the Trustee is not allowed to transfer the asset, but upon a sale of the asset to the Buyer, can and does modify owner-beneficiary information—changing it from the wallet address of Asset Creator (Original Owner) to the wallet address of Buyer. First, the Asset Creator (Original Owner) selects asset to place in trust, sets creator royalty rate 401 (which will be incorporated into the TrusteeNFT). Next, the NFT Marketplace Platform creates and mints a restricted transfer TrusteeNFT for the asset with owner listed as Trustee's wallet address. Within the TrusteeNFT, on-chain or off-chain metadata lists creator-beneficiary and owner-beneficiary as Asset Creator's wallet address. The TrusteeNFT provides approval to the NFT Creator Marketplace Platform to edit the owner-beneficiary data (on-chain or off-chain) upon a sale to a buyer 402. The Asset Creator opts to auction or sell the asset 403 and the NFT Creator Marketplace Platform auctions/sells the asset to the Buyer 404. The NFT Creator Marketplace Platform records the transaction on a blockchain by updating the owner-beneficiary data (on-chain or off-chain) to the Buyer's wallet address. The TrusteeNFT pays Asset Creator full amount less any platform/gas/trustee fees 405. Dynamic NFTs (dNFTs) can be used to update the owner-beneficiary data so that the trustee can keep the asset in trust and the NFT marketplace only needs to update the beneficiary field upon a sale to a Buyer or NewBuyer (as described below with FIG. 4b).

FIG. 4b shows the second part of the second embodiment of the invention where upon a sale of the asset to the NewBuyer, Trustee modifies owner-beneficiary information—changing it from the wallet address of Buyer to the wallet address of NewBuyer. After buying his interest in the asset, Buyer, through the TrusteeNFT, only can opt to auction or sell the asset and to collect its share of royalties. The Buyer first opts to auction or sell the asset 406 and auctions or sells the asset to the NewBuyer 407. The NFT Creator Marketplace Platform records the transaction on a blockchain by updating the owner-beneficiary data (on-chain or off-chain) to the New Buyer's wallet address. The TrusteeNFT then pays Asset Creator the guaranteed secondary sale royalties and pays the Buyer the full amount less the guaranteed secondary sales royalties and any platform/gas/trustee fees 408.

As the trustee is not involved in the payment process, security could become a concern because fans will be able to see the wallet address of the asset creator. However, an artist could use a digital asset trust wallet as described in the prior art.

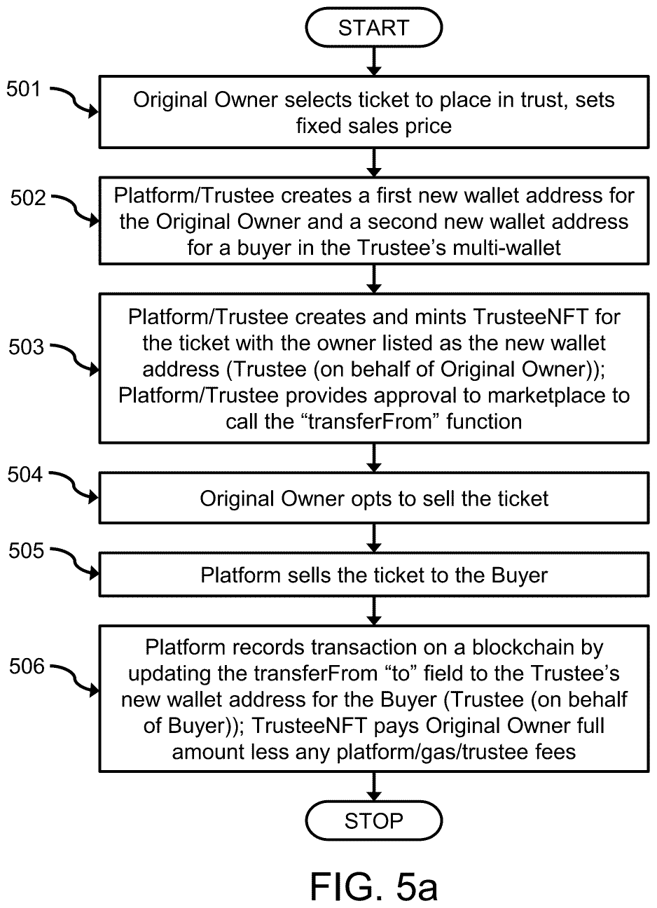

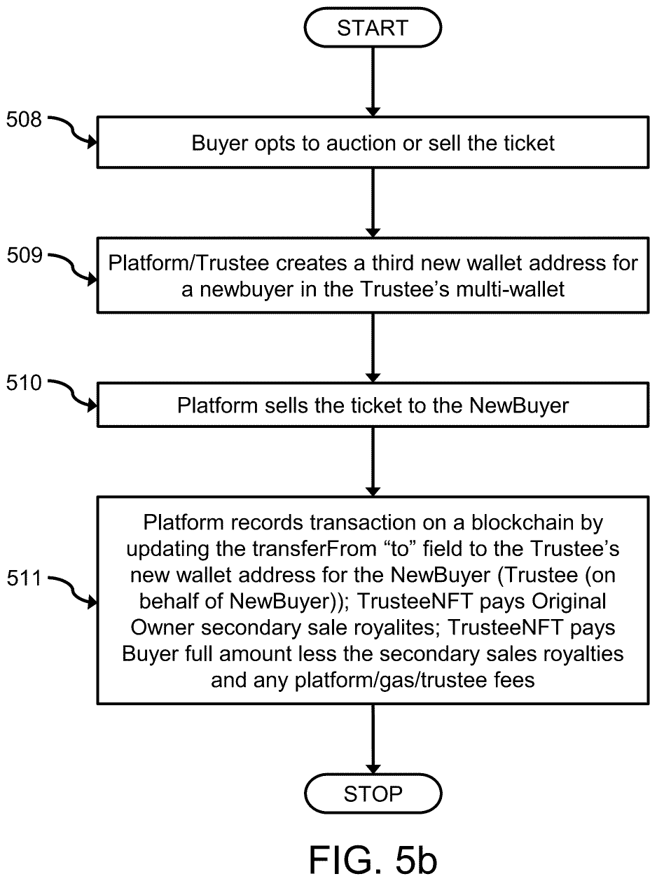

FIG. 5a and FIG. 5b show the third embodiment of the invention where the Trustee uses a multi-wallet to keep interests separate while transferring interests in a ticket (e.g., a concert ticket) from a seller to buyer.

FIG. 5a shows the first part of the third embodiment of the invention where the Trustee uses a first address in the Trustee's multi-wallet to hold the ticket for the Original Owner and a second address in the Trustee's multi-wallet (for the Buyer) to receive the ticket upon a sale to the Buyer. First, the Original Owner selects a ticket to place in trust and sets a fixed sales price 501. The NFT Ticketing Platform (as Trustee) creates a first new wallet address for the Original Owner and a second new wallet address for a (future) buyer in the Trustee's multi-wallet 502. The NFT Ticketing platform creates and mints a TrusteeNFT for the ticket with the owner listed as the new wallet address for the Original Owner (a wallet address representing “Trustee (for the benefit of Original Owner).” The NFT Ticketing platform provides approval to marketplace to call the “transferFrom” function—transfer will be to the pre-created wallet address for the (future) buyer 503.

The Original Owner (or the Trustee) then opts to auction or sell the ticket 504 at the fixed sales price (or the fixed sales price plus a Trustee/platform fee as defined in an agreement with the Original Owner and the Trustee/NFT Ticketing Platform). The NFT Ticketing Platform auctions or sells the ticket to Buyer 505. The NFT Ticketing Platform records the transaction on a blockchain by updating the transferFrom “to” field to the Trustee's new wallet address for the Buyer (a wallet address representing “Trustee (for the benefit of Buyer)”). The TrusteeNFT then pays Original Owner full amount less any platform/gas/trustee fees 506.

FIG. 5b shows the second part of the third embodiment of the invention where the Trustee uses third address in the Trustee's multi-wallet (for the NewBuyer) to receive the ticket upon a sale to a NewBuyer. The Buyer first opts to auction or sell the ticket 508. The NFT Ticketing platform (as Trustee) creates a third new wallet address for a (future) newbuyer in the Trustee's multi-wallet 509. The NFT Creator Marketplace auctions or sells the ticket to NewBuyer 510 at the fixed sales price (or the fixed sales price plus a Trustee/platform fee as defined in the agreement between the Original Owner and Trustee/NFT Ticketing Platform. The NFT Ticketing Platform records the transaction on a blockchain by updating the transferFrom “to” field to the Trustee's new wallet address for the NewBuyer (a wallet address representing “Trustee (for the benefit of NewBuyer)”). The TrusteeNFT then pays Original Owner the guaranteed secondary sale royalties and pays the Buyer the full amount less the guaranteed secondary sales royalties and any platform/gas/trustee fees 511.

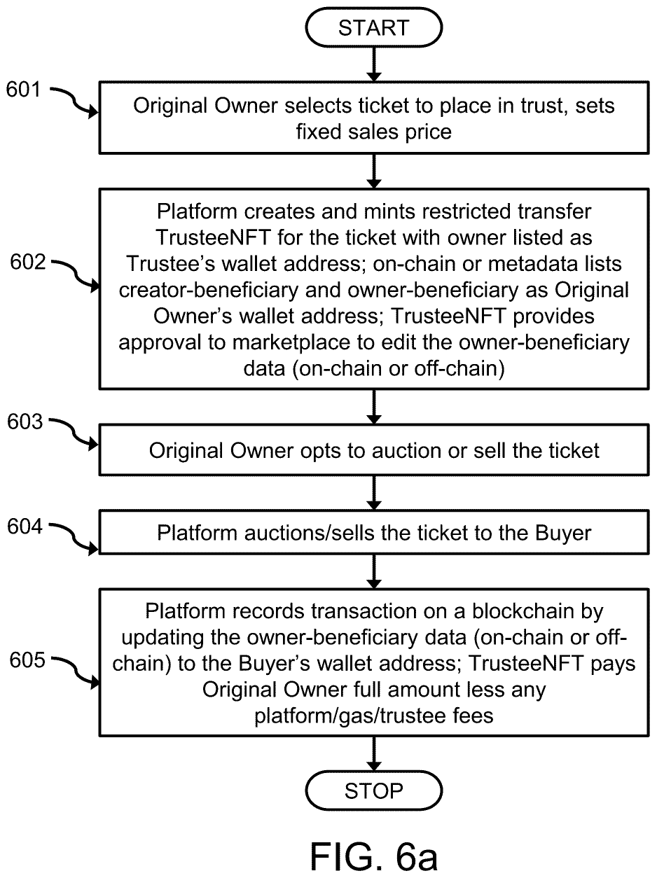

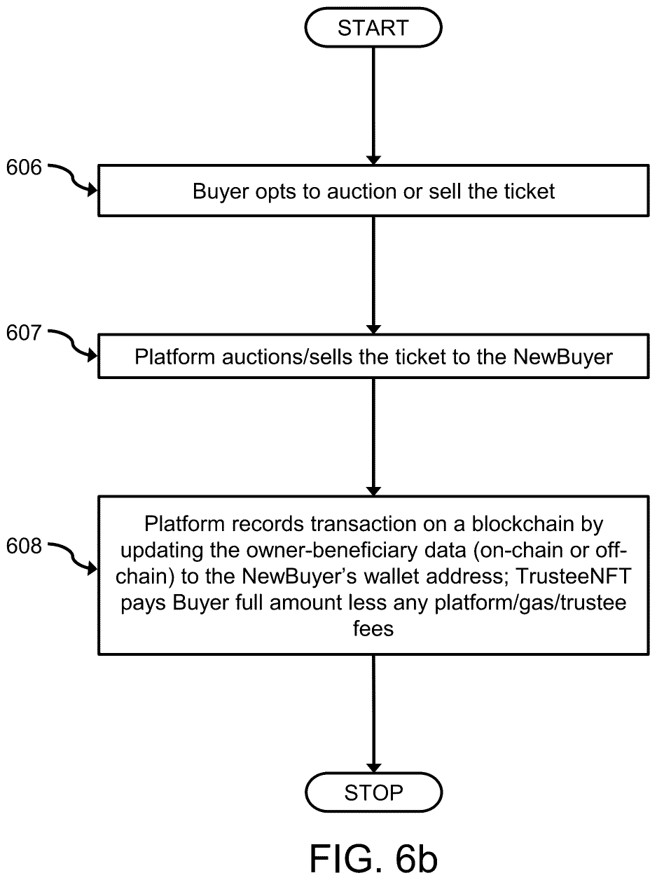

FIG. 6a and FIG. 6b show the fourth embodiment of the invention where the Trustee's wallet holds a ticket for the beneficiaries. Upon a sale, the TrusteeNFT only modifies owner-benficiary information to keep track of the current owner.

FIG. 6a shows the first part of the fourth embodiment of the invention where the Trustee is not allowed to transfer the ticket, but upon a sale of the ticket to the Buyer, the TrusteeNFT can and does modify owner-beneficiary information—changing it from the wallet address of Original Owner to the wallet address of Buyer. First, the Original Owner selects ticket to place in trust, sets a fixed sales price 601 (which will be incorporated into the TrusteeNFT). Next, the NFT Ticketing Platform creates and mints a restricted transfer TrusteeNFT for the ticket with owner listed as Trustee's wallet address. Within the TrusteeNFT, on-chain data or metadata lists the owner-beneficiary as Original Owner's wallet address. The TrusteeNFT provides approval to the NFT Ticketing Platform to edit the owner-beneficiary data (on-chain or off-chain) upon a sale to a buyer 602. The Original Owner opts to auction or sell the ticket 603 and the NFT Ticketing Platform auctions/sells the ticket to the Buyer 604. The NFT Ticketing Platform records the transaction on a blockchain by updating the owner-beneficiary data (on-chain or off-chain) to the Buyer's wallet address. The TrusteeNFT pays the Original Owner full amount less any platform/gas/trustee fees 605. Dynamic NFTs (dNFTs) can be used to update the owner-beneficiary data so that the trustee can keep the asset in trust and the NFT marketplace only needs to update the beneficiary field upon a sale to a Buyer or NewBuyer (as described below with FIG. 6b).

FIG. 6b shows the fourth part of the fourth embodiment of the invention where upon a sale of the ticket to the NewBuyer, the TrusteeNFT modifies owner-beneficiary information—changing it from the wallet address of the Buyer to the wallet address of NewBuyer. After buying his interest in the ticket, Buyer, through the TrusteeNFT, only has the ability to opt to auction or sell the ticket and to collect its share of royalties. The Buyer first opts to auction or sell the ticket 606 and auctions or sells the ticket to the NewBuyer 607. The NFT Ticketing Platform records the transaction on a blockchain by updating the owner-beneficiary data (on-chain or off-chain) to the New Buyer's wallet address. The TrusteeNFT then pays the Buyer the full amount less any platform/gas/trustee fees 608.

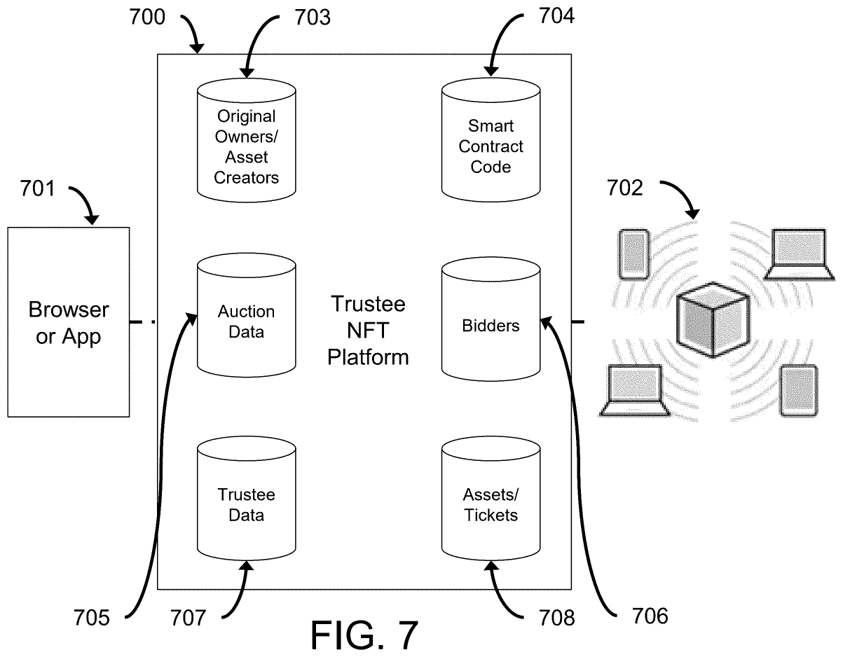

FIG. 7 shows the structure of the Trustee NFT Platform. The Asset Creator/Original Owner uses a browser or app 701 to interact with the Trustee NFT Platform 700. The Trustee NFT Platform 700 enables asset creators to have an asset held in trust by a Trustee (e.g., NFT Creator Marketplace Platform, NFT Ticketing Platform, trustee crypto wallet, or DAO) to prevent wrapping on a blockchain 702. The TrusteeNFT Platform 700 creates TrusteeNFTs based on data stored in an Original Owner/Asset Creator database 703, a smart contract code database 704, an auction/pricing database 705, a bidder/buyer database 706, a database of trustees 707, and a database of assets/tickets 708.

The Smart Contract Code 704 serves as the bridge between the NFT platform 700 and the blockchain 702, executing operations that require transparency, automation, and decentralization. It interacts directly with the blockchain 702 to perform on-chain operations such as minting NFTs, recording asset ownership, processing transfers, and enforcing royalty payments during sales. However, not all processes are performed on-chain. Some operations may be managed off-chain by the platform to reduce transaction costs (gas fees) and improve speed and scalability. Factors such as cost-efficiency, the need for transparency, and the frequency of updates determine whether an operation occurs on-chain or off-chain.

This invention, the TrusteeNFT Platform 700, can be implemented in digital electronic circuitry, computer hardware, firmware, software, or in combinations thereof. The invention can be implemented as a computer program product such as a computer program tangibly embodied in an information carrier (e.g., in a machine-readable storage device or in a propagated signal), for execution by, or to control the operation of, data processing apparatus (e.g., a programmable processor, a computer, or multiple computers). A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

The code for determining how assets/tickets and payments are distributed among parties can be implemented either in a centralized system or within a smart contract. When implemented in a smart contract, the distribution logic is automated, transparent, and trustless, ensuring that all parties receive their entitled assets or payments directly on the blockchain. Alternatively, a centralized system can manage the distribution logic, offering greater flexibility and cost efficiency, particularly for features requiring real-time updates or complex decision-making not well-suited to blockchain execution. The choice depends on the specific needs for transparency, performance, and cost-effectiveness in the platform's design.

### Gifting/Transfer

In one embodiment, the TrusteeNFT platform also enables conditional gifting of assets while preserving enforcement of rights and preventing circumvention. For example, a Beneficiary may initiate a gift of their interest in the asset to another party. To mitigate abuse scenarios such as stealth scalping or straw buyers, the gifting process can include one or more of the following features:
1. Pre-claim and Acceptance: The recipient of a gifted asset must claim or accept the gift through the platform prior to the transfer taking effect. If the recipient does not complete this process within a specified time window (e.g., 24-48 hours before an event), the gifting party retains the right to rescind or reassign the gift.
2. Revocability Options: Gifting can be configured in either revocable or irrevocable modes. In revocable gifting, the original beneficiary retains the ability to reclaim the gifted rights until the moment of redemption or until the event start time. This balances flexibility for genuine transfers (e.g., last-minute changes) with protection against misuse.
3. Gifting with Confirmation at Redemption: To ensure the gifted asset is used only by the intended recipient, redemption of the rights (e.g., ticket scanning at the event) can require the recipient to confirm identity via KYC verification or a pre-registered credential (such as email verification, phone OTP, or blockchain-based proof of identity).
4. Automatic Conversion to Revocable: Optionally, if a gift recipient claims the asset but does not redeem it by a defined time (for example, shortly before the event), the asset can automatically revert to a revocable status, allowing the gifter to reassign or resell.

These gifting mechanisms ensure that TrusteeNFT-enforced assets maintain their enforceability and intended economic model, even when transferred without payment.

Unlike traditional NFTs, where transfer equates to unconditional ownership, the TrusteeNFT system preserves a layer of trustee oversight. Even when an asset is gifted, the trustee remains legally and technically obligated to enforce the creator's terms—such as royalty obligations, resale pricing restrictions, and transfer conditions. This approach makes it possible to support scenarios such as:
1. Parental gifting to minors (e.g., a parent gifting a child a concert ticket, while retaining revocation rights).
2. Last-minute emergency transfers without exposing the asset to scalping.
3. Secure, fully tracked gifting of IP assets for promotional purposes.

This dual-token architecture, combined with trustee enforcement, ensures that gifting remains a compliant, auditable, and enforceable transaction—not merely a transfer of a speculative digital object.

### Programmable Banking

In certain embodiments, the TrusteeNFT system may be employed to provide programmable banking and custody services for both digital and tokenized real-world assets. Deposits of fiat currency, cryptocurrencies, or tokenized assets are linked to one or more NFTs issued to users. Each NFT is governed by smart contract logic defining rights, risk allocations, withdrawal conditions, and recovery guarantees. These NFTs function as programmable trust instruments, combining enforceable fiduciary duties under trust law with algorithmic control of asset flows, thereby reducing the need for discretionary human intervention in banking operations.

The system may be organized as a decentralized autonomous organization (DAO) operating under a legal wrapper, such as a Wyoming DAO LLC or Cayman foundation, that serves as the trustee. This DAO-trust hybrid enters into contractual agreements with one or more licensed banks or trust companies to hold fiat and cryptocurrency deposits. The NFTs issued by the DAO constitute equitable interests in these trust accounts, representing programmable rights enforceable both on-chain (via smart contracts) and off-chain (under trust law). DAO governance determines reserve ratios, lending parameters, and recovery rules, while fiduciary duties are codified in the trust agreement and mirrored in the smart contract code.

Partner banks provide insured custody of fiat assets and, in some embodiments, cryptocurrency custody. These banks expose APIs for deposits, withdrawals, and balance reporting. The TrusteeNFT smart contracts integrate with the bank APIs through an oracle service that regularly posts proofs of reserves and transaction events to the blockchain. This architecture enables users to verify asset backing in real time and supports scalability across multiple banks, with the DAO managing allocation and risk diversification behind a unified on-chain interface.

When a user deposits assets, the system mints an NFT representing the deposit. This NFT includes metadata specifying deposit amount, denomination, applicable risk tier (e.g., 80% guaranteed safe, 20% at risk), recovery floor amounts in case of failure, withdrawal conditions, KYC/AML verification status, and governance parameters (such as voting rights or lending pool participation). The NFT serves as the user's programmable account key, allowing access to withdrawals, transfers, and recovery processes.

The system implements predictable risk tiers in which defined percentages of deposits are available for lending or yield generation while the remainder remains as instantly withdrawable reserves. For example, the first one million dollars of a deposit may have 80% in safe reserve and 20% placed at risk, while amounts exceeding one million may have a higher risk allocation (e.g., 50/50 split). DAO governance can adjust these parameters through proposals, with changes applying to future deposits or, in some embodiments, retroactively to existing NFTs following a notice period.

Each NFT may encode pre-set recovery floors, defining minimum guaranteed returns in failure scenarios. Recovery amounts are visible to the user and determinable in advance. An oracle retrieves balances from the partner banks and posts cryptographic proofs of reserve levels to the blockchain, enabling transparent verification of system solvency. This level of transparency directly addresses issues highlighted by failed centralized exchanges, such as FTX, where commingling of customer funds and opaque internal accounting led to catastrophic losses. By contrast, the TrusteeNFT framework enforces separation of reserves, provides real-time solvency proofs, and encodes recovery guarantees visible to all participants.

The system incorporates decentralized identity primitives (e.g., soulbound tokens or verifiable credentials) to link NFTs to verified users without centralized custody of private keys. Smart contract logic enforces compliance with KYC/AML requirements and jurisdictional restrictions. Account recovery is supported through multi-signature or DAO-governed processes that reissue NFTs upon verified identity proofs, allowing restoration of access if a private key is lost.

The DAO functions in a fiduciary capacity, bound by the trust agreement to act in the best interests of beneficiaries (NFT holders). Governance proposals approve new banking partners, set risk policies, and manage lending allocations, with fiduciary duties enforced both legally and programmatically. Unauthorized actions exceeding defined parameters (e.g., diverting reserves) are blocked at the smart contract level.

For example, a depositor placing $1,000,000 into the trust triggers NFT issuance with an 80/20 safe-risk allocation and an $ 800,000 recovery floor. Proofs of reserves are viewable on-chain, and DAO votes may direct the 20% risk portion into approved yield strategies. If the depositor loses their wallet, they can verify identity to trigger NFT reissuance without requiring centralized control.

This programmable banking model combines the safety and enforceability of traditional fiduciary banking with the transparency and composability of blockchain systems. It supports individuals, institutions, and platforms seeking predictable, programmable custody and lending solutions. The framework scales to multiple banks, accommodates tokenized real-world assets, and extends naturally to programmable stablecoins, credit, and cross-border settlement.

As used herein, the term “trust asset” refers to any item capable of being represented, stored, or transacted on a blockchain or distributed ledger. This includes, without limitation, native digital assets such as cryptocurrencies, stablecoins, fungible or non-fungible tokens (NFTs), and other blockchain-native tokens that inherently embody value, rights, or functionality. The term further encompasses tokenized representations of real-world assets, including but not limited to physical goods, event tickets, financial instruments such as equities, bonds, or commodities, and intellectual property rights such as copyrights, trademarks, or patents. Additionally, “trust asset” covers rights, licenses, or entitlements that may be represented in tokenized form, such as fractional ownership interests, royalty rights, usage licenses, or voting rights. This definition is intended to broadly encompass assets auctioned, sold, or otherwise transacted using the systems described herein, including creative marketplaces, ticketing platforms, and programmable banking applications, regardless of whether the underlying asset originates on-chain or off-chain. Each computer includes a network interface, a processor, and memory. Example implementations of the computers include, but are not limited to, personal computers (PC), Macintosh computers, server computers, blade servers, workstations, laptop computers, kiosks, hand-held devices, such as a personal digital assistant (PDA), mobile phones, smartphones, tablets, and network terminals.

As used herein, the term “soulbound token” (SBT) refers to a non-transferable blockchain token permanently associated with a specific wallet or account. In the context of this invention, SBTs may represent verified attributes of a user, such as identity, compliance status (e.g., KYC/AML verification), or eligibility to participate in specific trust or banking functions. The non-transferable nature of SBTs ensures a persistent link between the verified individual and the associated programmable trust instruments (e.g., TrusteeNFTs), enabling features such as account recovery, enforcement of jurisdictional restrictions, and prevention of unauthorized transfer of identity-linked privileges.

As used herein, the term a “decentralized autonomous organization” (DAO) refers to an organizational structure implemented through smart contracts on a blockchain network, where governance decisions and operational rules are executed programmatically rather than through centralized human management. In the context of this invention, the DAO may serve as a legally recognized trustee entity (e.g., via a DAO LLC or foundation) that governs the programmable trust instruments described herein, including control over reserve policies, lending allocations, risk tiers, and recovery parameters. DAO governance actions may be performed through token-weighted voting, multi-signature approvals, or other consensus mechanisms encoded in the system's smart contracts, providing fiduciary management of assets held in trust on behalf of NFT holders.

Method steps of the invention can be performed by one or more programmable processors executing a computer program to perform functions of the invention by operating on input data and generating output. Method steps can also be performed by, and apparatus of the invention can be implemented as, special purpose logic circuitry, such as an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for executing instructions and one or more memory devices for storing instructions and data. Generally, a computer will also include, or be operatively coupled to receive data from or transfer data to, one or more mass storage devices for storing data (e.g., magnetic, magneto optical disks, or optical disks). Information carriers suitable for embodying computer program instructions and data include all forms of non-volatile memory, including by way of example semiconductor memory devices (e.g., EPROM, EEPROM, and flash memory devices; magnetic disks such as internal hard disks or removable disks; magneto-optical disks; and CD ROM and DVD-ROM disks). The processor and the memory can be supplemented by, or incorporated in, special purpose logic circuitry.

A network interface is in communication with the one or more databases (such as Oracle) for receiving data from the asset creator(s) and bidder(s) and transfers data to the winning bidders and the blockchain as shown in FIG. 9 and FIG. 10. The communication can be across a network (not shown), embodiments of which include, but are not limited to, local-area networks (LAN), metro-area networks (MAN), and wide-area networks (WAN), such as the Internet or World Wide Web.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar references in the context of this disclosure (especially in the context of the following claims) are to be construed to cover both the singular and the plural, unless otherwise indicated herein or clearly contradicted by context. All methods described herein can be performed in any suitable order unless otherwise indicated herein or otherwise clearly contradicted by context. The use of any and all examples, or exemplary language (e.g., such as, preferred, preferably) provided herein, is intended merely to further illustrate the content of the disclosure and does not pose a limitation on the scope of the claims. No language in the specification should be construed as indicating any non-claimed element as essential to the practice of the present disclosure.

Multiple embodiments are described herein, including the best mode known to the inventors for practicing the claimed invention. Of these, variations of the disclosed embodiments will become apparent to those of ordinary skill in the art upon reading the foregoing disclosure. The inventors expect skilled artisans to employ such variations as appropriate (e.g., altering or combining features or embodiments), and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

In the event of inconsistent usages between this document and those documents so incorporated by reference, the usage in the incorporated reference(s) should be considered supplementary to that of this document; for irreconcilable inconsistencies, the usage in this document controls.

We claim:

1. A method, the method comprising:
storing, in a memory, a definition of an asset to be held in trust;
executing, by one or more processors, instructions to generate a trustee token associated with the asset, the trustee token representing custodial or fiduciary control of the asset;
transferring, by the one or more processors via a network interface, the trustee token to a first wallet address associated with a trustee, wherein a transfer of the trustee token to the first wallet address is recorded on a blockchain, and wherein the trustee holds the asset in trust for at least one beneficiary;
executing, by the one or more processors, instructions to generate a beneficiary token associated with the asset, the beneficiary token representing one or more rights in the asset;
transferring, by the one or more processors via the network interface, the beneficiary token to a beneficiary wallet address distinct from the first wallet address, wherein the beneficiary token functions as a cryptographic receipt evidencing rights granted to the beneficiary while ownership or control of the asset remains with the trustee via the trustee token.

2. The method of claim 1, wherein the trustee comprises at least one of a decentralized autonomous organization, a regulated custodian, a trust company, a smart-contract-controlled wallet, or an entity associated with the one or more processors.

3. The method of claim 1, wherein the beneficiary token is non-transferable or soulbound.

4. The method of claim 1, further comprising revoking, burning, or invalidating the beneficiary token upon a transfer of the beneficiary's rights in the asset.

5. The method of claim 1, wherein the first wallet address is one of a plurality of wallet addresses controlled by the trustee, each wallet address corresponding to a different beneficiary.

6. The method of claim 1, wherein information identifying the beneficiary or the rights represented by the beneficiary token is stored on-chain, off-chain, or in a combination thereof.

7. The method of claim 1, wherein information identifying the beneficiary is stored off-chain to limit public disclosure of beneficiary information.

8. The method of claim 1, wherein the blockchain comprises Ethereum or an Ethereum Virtual Machine-compatible blockchain.

9. The method of claim 1, wherein the beneficiary token represents at least one of:
a right to receive proceeds from a transfer of the asset;
a right to use the asset; or
a right to receive royalties associated with the asset.

10. The method of claim 1, wherein the asset comprises one or more of:
intellectual property rights;
a license or usage right;
a ticket or access credential;
a digital currency or stablecoin; or
a tokenized real-world asset.

11. A system, the method comprising:
a memory configured to store a definition of an asset to be held in trust;
one or more processors operatively coupled to the memory;
a network interface operatively coupled to the one or more processors;
wherein the one or more processors are configured to:
generate a trustee token associated with the asset, the trustee token representing custodial or fiduciary control of the asset;
transfer, via the network interface, the trustee token to a first wallet address associated with a trustee, wherein a transfer of the trustee token to the first wallet address is recorded on a blockchain, and wherein the trustee holds the asset in trust for at least one beneficiary;
generate a beneficiary token associated with the asset, the beneficiary token representing one or more rights in the asset; and
transfer, via the network interface, the beneficiary token to a beneficiary wallet address distinct from the first wallet address, wherein the beneficiary token functions as a cryptographic receipt evidencing rights granted to the beneficiary while ownership or control of the asset remains with the trustee via the trustee token.

12. The system of claim 11, wherein the trustee comprises at least one of a decentralized autonomous organization, a regulated custodian, a trust company, a smart-contract-controlled wallet, or an entity associated with the one or more processors.

13. The system of claim 11, wherein the beneficiary token is non-transferable or soulbound.

14. The system of claim 11, wherein the one or more processors are further configured to revoke, burn, or invalidate the beneficiary token upon a transfer of the beneficiary's rights in the asset.

15. The system of claim 11, wherein the first wallet address is one of a plurality of wallet addresses controlled by the trustee, each wallet address corresponding to a different beneficiary.

16. The system of claim 11, wherein information identifying the beneficiary or the rights represented by the beneficiary token is stored on-chain, off-chain, or in a combination thereof.

17. The system of claim 11, wherein information identifying the beneficiary is stored off-chain to limit public disclosure of beneficiary information.

18. The system of claim 11, wherein the blockchain comprises Ethereum or an Ethereum Virtual Machine-compatible blockchain.

19. The system of claim 11, wherein the beneficiary token represents at least one of: (a) a right to receive proceeds from a transfer of the asset; (b) a right to use the asset; or (c) a right to receive royalties associated with the asset.

20. The system of claim 11, wherein the asset comprises one or more of: (a) intellectual property rights; (b) a license or usage right; (c) a ticket or access credential; (d) a digital currency or stablecoin; or (e) a tokenized real-world asset.
